(19) United States
(12) Patent Application Publication
(10) Pub. No.: US 2009/0306060 A1
(43) Pub. Date: Dec. 10, 2009

(54) METHOD FOR IMPROVING SEED LOT QUALITY

(75) Inventor: Clifford Watrin, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 11/720,905

(22) PCT Filed: Dec. 7, 2005
(86) PCT No.: PCT/US2005/044441

§ 371 Date: Aug. 10, 2009

Related U.S. Application Data
(60) Provisional application No. 60/634,480, filed on Dec. 9, 2004.

(51) Int. Cl. A01N 43/88; A01N 43/54; A01N 43/40; A01N 43/36; A01N 37/18; A01N 33/24; A01P 3/00

(52) U.S. Cl. 514/229.2; 514/269; 514/345; 514/422; 514/427; 514/539; 514/640

(57) ABSTRACT

The present invention relates to a method for improving seed lot quality, seed shelf life, and seed lot retention, comprising applying to a seed within the seed lot an effective amount of a strobilurin fungicide alone, or in combination with at least one additional fungicide. In a preferred embodiment, the additional fungicide is at least one phenylpyrrole type fungicide and/or at least one phenylpyrrole type fungicide.

The present invention relates to a method for improving seed lot quality, seed shelf life, and seed lot retention, comprising applying to a seed within the seed lot an effective amount of a strobilurin fungicide alone, or in combination with a phenylpyrrole type fungicide and/or a phenylamide type fungicide.

Growers measure seed quality, and thus their potential for profitability, by measuring the germination of the seeds. Additionally, once the seed germinates, the health of the plant, measured by plant stand, vigor, and yield, also factors into the growers' assessment of quality and potential profitability.

Seed borne diseases are known to be major contributors to reduced seed quality, resulting in reduced germination, reduced plant stand establishment, reduced plant vigor, and reduced plant yield. Because seed borne diseases readily transfer from seed to seed in a given lot, rampant infection by seed borne diseases often results in seed lots being rejected by seed companies. Such rejection leads to lost profits for the seed companies, as many plants, especially hybrids and varieties grown specifically for seed generation, are deemed unmarketable if the quality of the plants used to produce seeds is low.

Generally, seed lots having a number of diseased, and thus discarded, seeds exceeding 15% are considered to be marginal lots. Because of the predicted failure of a marginal seed lot due to contamination by diseased seeds, growers discard the entire lot rather than gamble on growth of the remaining seeds in that lot.

It has now been discovered that the overall health of a seed lot is improved by the treatment for seed borne diseases. That is, by treating the surface of a seed that is internally infected by fungal pathogens with strobilurin type fungicides, alone or in combination with phenylpyrrole type fungicides and/or phenylamide type fungicides, there is an overall curative effect on the seed. This curative effect is measured by increased germination and shelf life of the seeds, and increased field performance of the plants resulting therefrom.

Additionally, the quality and health of the entire seed lot is improved by treatment of seeds with a strobilurin type fungicide, alone or in combination with phenylpyrrole type fungicides and/or phenylamide type fungicides. Surprisingly, the present inventors have found that the overall quality of a seed lot can be improved by such treatment, resulting in a greater tolerance for diseased seeds within the lots and less lots being rated as marginal. As a result, a greater number of seed lots can be retained, even though the number of infected seeds would otherwise cause the lot to be rated marginal.

### DETAILED DESCRIPTION OF THE INVENTION

Strobilurin type fungicides include, but are not limited to azoxystrobin, fluoxastrobin, trifloxystrobin, dimoxystrobin, fenamidone, pyraclostrobin, famoxodone, metominostrobin, kresoxim-methyl and picoxystrobin; preferably azoxystrobin, fluoxastrobin, trifloxystrobin, and picoxystrobin

Phenylpyrrole type fungicides include, but are not limited to fenpiconyl and fludioxonil. See, for example, the Pesticide Manual, 13th Ed. (2004), The British Crop Protection Council, London, wherein fludioxonil is entry 368 and fenpiconyl is entry 341.

Phenylamide type fungicides include, but are not limited to benalaxyl, benalaxyl-M, metalaxyl, metalaxyl-M; advantageously one or more of metalaxyl and metalaxyl-M. See, for example, the Pesticide Manual, 13th Ed. (2004), The British Crop Protection Council, London, entry 516 for metalaxyl, entry 517 for metalaxyl-M, entry 56 for benalaxyl and entry 410 for furalaxyl.

The quality or health of a seed is measured as a combination of several factors including plant stand, germination, and plant vigor. Plant stand is measured as the density of crops per given area. Germination is a measurement of the number of seeds sprouting. Vigor is a measurement of the plant's ability to survive and grow when planted in a standard environment.

Seed lots are rated as acceptable or marginal, depending on the overall health of the seeds contained therein. Lots having greater than 88 percent healthy seeds are usually acceptable and routinely accepted by the grower. Currently in the industry, lots having less than 85 percent healthy seeds are unacceptable, labeled as marginal, and rejected in their entirety by the grower.

By treating seeds in a seed lot with a strobilurin type fungicide, alone or in combination with phenylpyrrole type fungicides and/or phenylamide type fungicides, the percentage of seeds discarded in a lot is reduced by the method of the present invention. Additionally, such treatment results in an overall improvement of the health and quality of the remaining seeds in the seed lot and an overall reduction in the number of discarded seed lots.

Accordingly, the present invention provides an improved quality of seed lots. Seed lots having between 80-85 percent healthy seeds are treated according to the process of the present invention to yield improved seed lots. Preferably, the number of healthy seeds in a treated seed lot is improved to between 81 and 85 percent More preferably, the number of healthy seeds in a treated seed lot is improved to between 82 to 85 percent, even more preferably between 83 and 85 percent, and most preferably between 84 and 85 percent.

By improving the number of healthy seeds in a lot, the retention of seed lots is increased. Retention rates for seed lots may be measured by the increased tolerance of infected seeds within a lot. For example, and not for limitation, seed lots having 80 percent healthy seeds and 20 percent infected seeds, prior to treatment, may now be retained. Preferably, seed lots having about 82 percent infected seeds prior to treatment may be retained after treatment. More preferably, seed lots having about 83 percent infected seeds prior to treatment may be retained. Most preferably, seed lots having up to about 84 percent infected seeds prior to treatment may be retained after treatment.

Application of the strobilurin, alone or in combination with phenylpyrrole type fungicides and/or phenylamide type fungicides, may be suitable for any seed. Particularly useful seeds treated by the method of the present invention include those subject to fungal pathogens associated with internal disease infections. More particularly, maize, including field corn, sweet corn and popcorn, cotton, potatoes, cereals, (wheat, barley, rye, oats, rice), sugar beet, cotton, millet varieties such as sorghum, sun flowers, beans, peas, oil plants such as rape, soybeans, cabbages, tomatoes, eggplants (aubergines), pepper and other vegetables and spices as well as ornamental shrubs and flowers and turf seeds are contemplated by the present invention. Seeds treated by the present invention also include hybrids of the classes described above.

Shelf life of seeds treated according to the present invention is also increased. Generally, corn seeds, including some hybrid corns, untreated or treated with a conventional fungicide may be stored for a period between 12 to 30 months. By way of example and not limitation, corn seeds, including some hybrid corns, treated with strobilurin type fungicides, alone or in combination with fludioxonil and/or mefenoxam, according to the present invention may be stored for a period up to about 48 months. Preferably, corn seeds treated according to the present invention may be stored for periods up to about 42 months, more preferably up to about 36 months and even more preferably up to about 30 months. For seeds such as soybeans, seeds treated according to the method of the present invention may be stored for periods up to about 30 months, preferably up to about 24 months, and more preferably up to about 18 months. Wheat seeds treated according to the present invention may be stored up to about 42 months, preferably up to about 36 months, more preferably up to about 30 months, even more preferably up to about 24 months.

The strobilurin type fungicide may be applied alone, or in combination with phenylpyrrole type fungicides and/or phenylamide type fungicides. Advantageous mixing ratios by weight of the three active ingredients, when used together, are strobilurin: phenylpyrrole type fungicides:phenylamide type fungicides=from 10:1:1 to 1:1:10 and to 1:10:1. For example, ratios of 2.5 g: 1 g: 1 g a.i./100 kg or 2.5 g: 1 g: 2.5 g a.i./100 kg or 2.5 g: 1 g: 5 g a.i./100 kg or 2.5 g: 1 g: 10 g a.i./100 kg of seed are suitable.

The compounds of this method are used in unmodified form or, preferably, together with the adjuvants conventionally employed in formulation technology. To this end they are conveniently formulated in known manner e.g. to emulsifiable concentrates, coatable pastes, directly sprayable or dilutable solutions, dilute emulsions, wettable powders, soluble powders, dusts, granulates, and also by encapsulation in e.g. polymer substances. As with the nature of the compositions, the methods of application, such as spraying, atomizing, dusting, scattering, coating tumbling, or pouring are chosen in accordance with the intended objectives and the prevailing circumstances recognized by one of ordinary skill in the art. Advantageous rates of application of the active ingredient mixture are normally from 0.5 g to 500 g, from 1 g to 100 g, or from 5 g to 50 g a.i. per 100 kg of seed.

In a particularly suitable method, the active ingredient strobilurin, alone or in combination with active ingredients phenylpyrrole type fungicides and/or phenylamide type fungicides, may be applied to plant propagation material, i.e. to seeds, tubers, fruit or other plant materials to be protected (e.g. bulbs, coating) by impregnating the seeds or seed materials either with a liquid formulation of the fungicides or coating them with a solid formulation.

The formulations are prepared in known manner, typically by intimately mixing and/or grinding the active ingredients with extenders, e.g. solvents, solid carriers and, where appropriate, surface-active compounds (surfactants).

Suitable solvents are: aromatic hydrocarbons, the fractions containing 8 to 12 carbon atoms, typically xylene mixtures or substituted naphthalenes, phthalates such as dibutyl or dioctyl phthalate, aliphatic hydrocarbons such as cyclohexane or paraffins; alcohols and glycols and their ethers and esters such as monomethyl ether, ketones such as cyclohexanone, strongly polar solvents such as N-methyl-2-pyrrolidone, dimethyl sulfoxide or dimethyl formamide, as well as vegetable oils or epoxidised vegetable oils; or water.

The solid carriers typically used for dusts and dispersible powders are calcite, talcum, kaolin, montmorillonite or attapulgite, highly dispersed silicic acid or absorbent polymers. Suitable granulated adsorptive granular carriers are pumice, broken brick, sepiolite or bentonite, and suitable non-sorptive carriers are typically calcite or dolomite.

Depending on the nature of the active ingredients to be formulated, suitable surface-active compounds are nonionic, cationic and/or anionic surfactants having good emulsifying, dispersing and wetting properties. The term “surfactants” will also be understood as comprising mixtures of surfactants.

The surfactants customarily employed in formulation technology may be found in the following literature:
“Mc Cutcheon's Detergents and Emulsifiers Annual” MC Publishing Corp., Glen Rock, N.J., 1988.
M. and J. Ash, “Encyclopedia of Surfactants”, Vol. I-III, Chemical Publishing Co., New York, 1980-1981.

By way of example, and not limitation, application-promoting adjuvants are also natural or synthetic phospholipids of the cephalin and lecithin series, e.g. phosphatidylethanolamine, phosphatidylserine, phosphatidylglycerol and lysolecithin.

The agrochemical compositions usually comprise 0.1 to 99%, preferably 0.1 to 95%, of active ingredients, 99.9 to 1%, preferably 99.9 to 5%, of a solid or liquid adjuvant, and 0 to 25%, preferably 0.1 to 25%, of a surfactant.

Whereas commercial products or wet or dry dressings will preferably be formulated as concentrates, the end user will normally use dilute formulations for treating plants or seeds as the case may be. However, ready to apply dilute solutions also are within the scope of the present invention.

The present inventors have now shown that application of strobilurin type fungicides, alone or in combination with phenylpyrrole type fungicides and/or phenylamide type fungicides, to seeds infected with fungal disease pathogens improve the health and quality of a seed. The treatment has a curative effect on the seed, which lengthens shelf life of the treated seed and improves the health of the seed lot.

Pathogens are mainly Pythium, Tilletia, Stenocarpella (diplodia), Gerlachia, Septoria, Ustilago, Fusarium, Rhizoctonia (so-called “damping off complex”). The active ingredients are also active against Oomycetes such as Phytophthora, Plasmopara, Pseudoperonospora, Bremia etc. as well as against the Botrytis species, Pyrenophora, Monilinia and further representatives of the Ascomycetes, Deuteromycetes and Basidiomycetes classes.

The quality or health of a harvested seed is measured as a combination of several factors including plant stand, germination, and plant vigor. Plant stand is measured as the density of crops per given area. Germination is a measurement of the number of seeds sprouting. Vigor is a measurement of the plant's ability to survive and grow when planted in a standard environment.

Seed germination testing is used to assess seed quality or viability and to predict performance of the seed and seedling in the field. Several different kinds of testing are available depending on the type of seed to be tested, the conditions of the test, and the potential uses of the seed. Two common tests are the warm germination test and the accelerated aging test. Each test is designed to evaluate various qualities of the seed. Factors that can affect the performance of seed in germination tests include; diseased seed, old seed, mechanically damaged seed, seed stored under high moisture, and excessive heating of seed during storage or drying.

A preferred test of seed germination is a warm germination test because it is used for labeling purposes. Germination is defined as: “the emergence and development from the seed embryo of those essential structures which are indicative of the ability to produce a normal plant under favorable conditions.” The warm germination test reflects the stand producing potential of a seed lot under ideal planting conditions. In a typical warm germination test, 400 seeds from each seed lot are placed under moist conditions on blotters, rolled towels, or sand and maintained at 77° F. for about seven days. At the end of this period the seedlings are categorized as normal, abnormal, or diseased, and dead or hard seeds. The percentage germination is calculated from the number of normal seedlings from the total number of seeds evaluated.

Another germination test, the accelerated aging test (AA), estimates the carryover potential of a seed lot in warehouse storage. The seeds are exposed to high temperatures and high relative humidity for short periods of time that cause seed deterioration. Seeds are suspended over water in a chamber for a period of time, for example 72 hours (wheat and soybeans) or 96 hours (corn), then tested in a standard warm germination test. This test only is usually used on seed whose longevity was in question.

### EXAMPLE 1

In the method of the present invention, plants treated with azoxystrobin, alone and in combination with fludioxonil, were tested for seed borne efficacy in seven hybrid corn varieties. Data is provided in Table 1.

| | IFSA Inbred | | IFSA Inbred | | IFSA Inbred | | IFSA Inbred | | IFSA Inbred | | IFSA Inbred | | IFSA Inbred | |
|---|---|---|---|---|---|---|---|---|---|---|---|---|---|---|
| | FR-A | | FR-C | | FR-D | | FR-F | | FR-G | | W-A | | W-B | |
| | PC # | GY | | GY | | GY | | GY | | GY | | GY | | GY |
| Treatment | (1) | BU (2) | PC # | BU | PC # | BU | PC # | BU | PC # | BU | PC # | BU | PC # | BU |
| Untreated | 21865 a | 178 a | 22890 b | 177 b | 23061 b | 188 a | 15203 c | 149 c | 9224 b | 81 a | 19474 a | 161 b | 21695 b | 200 a |
| Check | | | | | | | | | | | | | | |
| Fludioxonil | 23744 a | 180 a | 23915 ab | 176 b | 24599 a | 185 a | 24428 a | 225 a | 11787 ab | 85 a | 19986 a | 180 ab | 22036 b | 204 a |
| 3.5 | | | | | | | | | | | | | | |
| GA/100 Kg | | | | | | | | | | | | | | |
| seed | | | | | | | | | | | | | | |
| Azoxy- | 23232 a | 168 a | 24086 ab | 187 ab | 23574 a | 193 a | 18107 bc | 179 b | 13153 a | 89 a | 19645 a | 173 ab | 23574 ab | 204 a |
| strobin 1 | | | | | | | | | | | | | | |
| GA/100 Kg | | | | | | | | | | | | | | |
| seed | | | | | | | | | | | | | | |
| Fludioxonil | 23061 a | 184 a | 24599 a | 195 ab | 24428 a | 188 a | 24428 a | 214 a | 13666 a | 102 a | 19816 a | 181 a | 23574 ab | 209 a |
| 3.5 | | | | | | | | | | | | | | |
| GA/100 Kg | | | | | | | | | | | | | | |
| seed + | | | | | | | | | | | | | | |
| Azoxy- | | | | | | | | | | | | | | |
| strobin 1 | | | | | | | | | | | | | | |
| GA/100 Kg | | | | | | | | | | | | | | |
| seed | | | | | | | | | | | | | | |
| Fludioxonil | 23403 a | 181 a | 24428 a | 198 a | 23574 a | 184 a | 19986 b | 183 b | 13495 a | 83 a | 19474 a | 172 ab | 24599 a | 215 a |
| 2.5 | | | | | | | | | | | | | | |
| GA/100 Kg | | | | | | | | | | | | | | |
| seed | | | | | | | | | | | | | | |

(1) PC # is Plaeme Coupla Number
(2) GY is Grain Yield in bushels
Different letters denote statistical significance (a, ab, b, c)

### EXAMPLE 2

Average germination of eleven hybrids were infected with Diplodia and other seedborne diseases wherein the untreated check was compared with seeds treated with (1) fludioxonil in combination with mefenoxam and (2) azoxystrobin with fludioxonil in combination with mefenoxam. The data is provided in Table 2.

| Treatment | Warm Germ % | Cold Germ % |
|---|---|---|
| Untreated | 73.8 a | 68.4 a |
| Fludioxonil + Mefenoxam | 89.5 e | 82.4 fe |
| Azoxystrobin 1.0 g + | 90.8 fg | 84.8 hg |
| Fludioxonil + Mefenoxam | | |
| LSD 0.05 | 1.29 | 2.21 |

As various changes could be made in the above methods and compositions without departing from the scope of the invention, it is intended that all matter contained in the above description shall be interpreted as illustrative and not in a limiting sense.

We claim:

1. A method for improving the quality of a seed lot having an untreated germination rate of less than 85 percent comprising treating the seeds within the seed lot with a strobilurin type fungicide, alone or in combination with at least one additional fungicide.

2. The method according to claim 1, wherein the strobilurin type fungicide is applied alone.

3. The method according to claim 2, wherein the strobilurin type fungicide is selected from the group consisting of azoxystrobin, fluoxastrobin, picoxystrobin, kresoxim-methyl, and trifloxystrobin.

4. The method according to claim 3, wherein the strobilurin type fungicide is azoxystrobin.

5. The method according to claim 1, wherein the strobilurin type fungicide is applied in combination with at least one additional fungicide.

6. The method according to claim 5, wherein the strobilurin type fungicide is selected from the group consisting of azoxystrobin, fluoxastrobin, picoxystrobin, and trifloxystrobin.

7. The method according to claim 6, wherein the strobilurin type fungicide is azoxystrobin.

8. The method according to claim 7, wherein the at least one additional fungicide is a phenylpyrrole type fungicide and a phenylamide type fungicide.

9. The method according to claim 8, wherein the phenylpyrrole type fungicide is selected from the group consisting of fludioxonil and fenpiconyl.

10. The method according to claim 8, wherein the phenylamide type fungicide is selected from the group consisting of benalaxyl, benalaxyl-M, metalaxyl, metalaxyl-M.

11. The method according to claim 7, wherein the phenylpyrrole type fungicide is fludioxonil and the phenylamide type fungicide is metalaxyl-M.

12. The method according to claim 1, wherein the health and quality of the seed lot is improved to having a germination rate of between 80-85 percent after treatment.

13. The method according to claim 12, wherein the germination rate is between 83-85 percent.

14. The method according to claim 13, wherein the germination rate is between 84 and 85 percent.

15. The method according to claim 11, wherein the health and quality of the seed lot is improved to having a germination rate of between 80-85 percent after treatment.

16. A method for improving shelf life of a seed comprising treating a seed with a strobilurin type fungicide, alone or in combination with at least one additional fungicide.

17. The method according to claim 16, wherein the strobilurin type fungicide is applied alone.

18. The method according to claim 17, wherein the strobilurin type fungicide is selected from the group consisting of azoxystrobin, fluoxastrobin, picoxystrobin, kresoxim-methyl, and trifloxystrobin.

19. The method according to claim 18, wherein the strobilurin type fungicide is azoxystrobin.

20. The method according to claim 18, wherein the at least one additional fungicide is a phenylpyrrole type fungicide and a phenylamide type fungicide.

21. The method according to claim 19, wherein the phenylpyrrole type fungicide is fludioxonil.

22. The method according to claim 20, wherein the phenylamide type fungicide is metalaxyl-M.

23. The method according to claim 20, wherein the phenylpyrrole type fungicide is fludioxonil and the phenylamide type fungicide is mefenoxam.

24. The method according to claim 16, wherein the seed is corn and the shelf life is up to about 48 months.

25. The method according to claim 24, wherein the shelf life is up to about 36 months.

26. The method according to claim 25, wherein the shelf life is up to about 30 months.
